(19) United States
(12) Patent Application Publication
(10) Pub. No.: US 2016/0350876 A1
(43) Pub. Date: Dec. 1, 2016

(54) SCHEDULING CONTENT GENERATION

(71) Applicant: Linkedln Corporation, Mountain View, CA (US)

(72) Inventors: Alexander Ovsiankin, Sunnyvale, CA (US); Daniel Wong, San Jose, CA (US); Rishi Jobanputra, Menlo Park, CA (US)

(21) Appl. No.: 15/041,623

(22) Filed: Feb. 11, 2016

Related U.S. Application Data
(60) Provisional application No. 62/168,526, filed on May 29, 2015.

(51) Int. Cl. G06Q 50/00; G06Q 10/06; G06Q 10/08

(52) U.S. Cl. CPC G06Q 50/01; G06Q 10/0833; G06Q 10/06398

(57) ABSTRACT

A machine may be configured to schedule the generation of content for members of a social networking service. For example, the machine identifies one or more members of a social networking service who are associated with an optimal delivery time that identifies a time that is optimal for transmitting an item of digital content to the one or more members. The machine schedules an execution of a job for generation of the item of digital content. The execution of the job is performed at a content generation time that is prior to the optimal delivery time. The machine executes the job at the content generation time. The executing generates the item of digital content. The machine transmits one or more communications including the item of digital content to one or more devices associated with the one or more members, at the optimal delivery time.

### CLAIM OF PRIORITY

This application claims the benefit of priority, under 35 U.S.C. Section 119(e), to U.S. Provisional Patent Application No. 62/168,526 by Ovsankin et al., filed on May 29, 2015, which is hereby incorporated herein by reference in its entirety.

### TECHNICAL FIELD

The present application relates generally to the processing of data, and, in various example embodiments, to systems, methods, and computer program products for scheduling the generation of content for members of a social networking service.

### BACKGROUND

Online entities communicate with users, such as readers or online purchasers, by means of various channels (e.g., web sites, email messages, blogs, etc.). An online entity may be an organization that has an online presence. Examples of online entities are online retailers, social networking services, business organizations, and educational institutions.

Traditionally, the content of digital communications produced by or for an online entity is generated for the purpose of consumption by a generic user targeted by the online entity. Such content usually is not customized to a particular user's interests, preferences, or habits.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a content generation system, according to some example embodiments;

FIG. 3 is a diagram illustrating a representation of a schedule for content generation and transmittal to members of a social networking service, according to some example embodiments;

FIG. 4 is a flowchart illustrating a method for scheduling content generation, according to some example embodiments;

FIG. 5 is a flowchart illustrating a method for scheduling content generation, and representing additional steps of the method illustrated in FIG. 4, according to some example embodiments;

FIG. 6 is a flowchart illustrating a method for scheduling content generation, and representing step 406 of the method illustrated in FIG. 4 in more detail and representing an additional step of the method illustrated in FIG. 4, according to some example embodiments;

FIG. 7 is a flowchart illustrating a method for scheduling content generation, and representing an additional step of the method illustrated in FIG. 4, according to some example embodiments;

FIG. 8 is a flowchart illustrating a method for scheduling content generation, and representing additional steps of the method illustrated in FIG. 4, according to some example embodiments;

FIG. 9 is a block diagram illustrating a mobile device, according to some example embodiments; and

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems for scheduling content generation are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

Generally, the content of digital communications produced by or for an online entity is generated for the purpose of consumption by a generic user targeted by the online entity. Such content usually is not customized to a particular user's interests, preferences, or habits. In addition, the digital content produced by or for the online entity may often be perceived as “stale” (e.g., untimely or late) when received by the user. For example, in the case of a member of a social networking service (also referred to hereinafter as “SNS”), such as the professional networking service LinkedIn®, a member is interested in receiving digital content from the social networking service that is informative, timely, and personalized to the member's interests or profile attributes. It may be beneficial to the member and the social networking service to generate digital content that is pertinent to the member's interests and that is delivered to the member at a time when the member is more likely to interact with (e,.g., click on, read, view, modify, etc.) the generated digital content.

According to certain example embodiments, the social networking system may utilize a content generation system that groups members of the social networking service into groups based on a particular optimal time of delivery of the digital content such that the likelihood of interacting with the transmitted digital content by the members in a group exceeds a threshold value. A content generation job may be assigned to generate one or more items of digital content for a particular group of members (e.g., a “slice” of the total membership of the SNS). The content generation system may also schedule a number of content generation jobs (also “jobs”) for each of the groups of members such that the content generation jobs run periodically, in a fault-tolerant manner. For example, as part of performing a fault-tolerant execution of content generation jobs, the content generation system determines that a first job that is scheduled to execute before a second job failed. The content generation system continues its operation and generates the digital content scheduled for the first job as part of the next (e.g., second) job that is executed.

In scheduling the execution of content generation jobs, the content generation system balances a number of factors for the purpose of delivering digital content to a particular member at the “right” time (e.g., the optimal time) for the particular member. Examples of such factors are the time identified to be the most likely time (e.g., during the day, week, or month) that the member interacts with the content; not generating the content too far in advance to avoid the content becoming stale; the time that the job may take to generate the content; the likelihood that the job will fail and that a next job generating the content of the previous, failed job exceeds the time scheduled for the next job; etc.

In some example embodiments, the content generation system identifies one or more members of the SNS who are associated with an optimal delivery time that identifies a time that is optimal for transmitting an item of digital content to the one or more members. The content generation system also schedules an execution of a job for generation of the item of digital content. The execution of the job is performed at a content generation time that is prior to the optimal delivery time in a time line of events (e.g., content generation jobs and content transmittal events). The content generation system may support multiple event cadencies (e.g., weekly, daily, sub-daily, etc.) The content generation system also executes the job at the content generation time. The executing of the job generates the item of digital content. The content generation system then transmits one or more communications including the item of digital content to one or more devices associated with the one or more members, at the optimal delivery time.

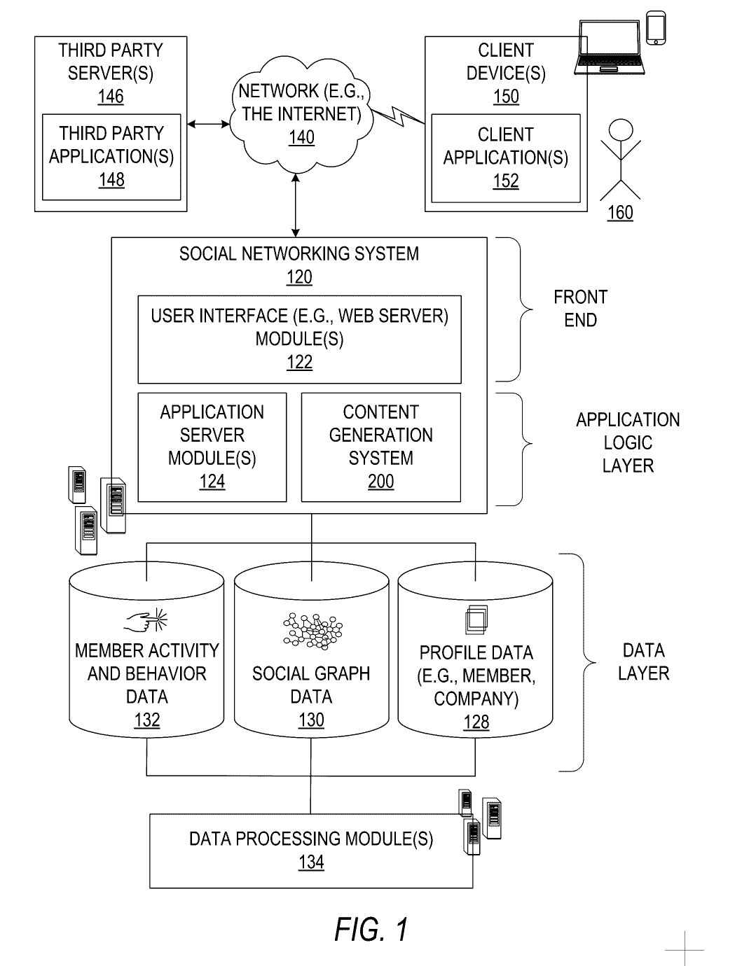

An example method and system for scheduling the generation of content for members of a social networking service may be implemented in the context of the client-server system illustrated in FIG. 1. As illustrated in FIG. 1, a content generation system 200 is part of a social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrahooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132. An example of such activity and behavior data is the date and/or time when the member is more likely to interact with digital content provided by the social networking system 120. This date and/or time may be identified by the content generation system 200 as the optimal date and/or time to transmit items of digital communication to the member.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive digital communications (e.g., advertising, news, status updates, etc.) targeted to them based on various factors (e.g., member profile data, social graph data, member activity or behavior data, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the content generation system 200, which is described in more detail below.

Further, as shown in FIG. 1, a data processing module 134 may be used with a variety of applications, services, and features of the social networking system 120. The data processing module 134 may periodically access one or more of the databases 128, 130, or 132, process (e.g., execute batch process jobs to analyze or mine) profile data, social graph data, or member activity and behavior data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

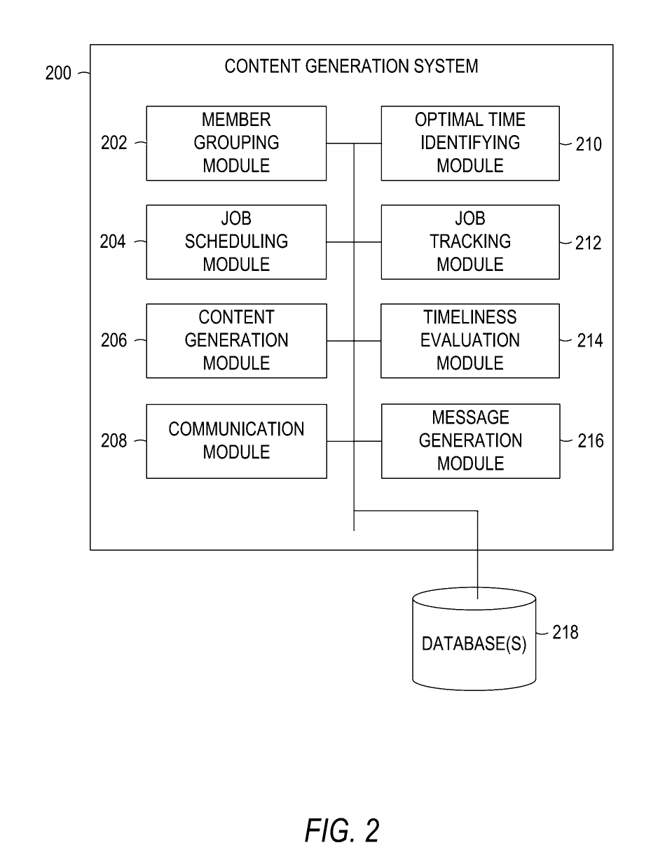

FIG. 2 is a block diagram illustrating components of the content generation system 200, according to some example embodiments. As shown in FIG. 2, the content generation system 200 includes a member grouping module 202, a job scheduling module 204, a content generation module 206, a communication module 208, an optimal time identifying module 210, a job tracking module 212, a timeliness evaluation module 214, and a message generation module 216, all configured to communicate with each other (e.g., via a bus, shared memory, or a switch).

According to some example embodiments, the member grouping module 202 identifies one or more members of a social networking service who are associated with an optimal delivery time. The optimal delivery time identifies a time that is optimal for transmitting an item of digital content to the one or more members.

The job scheduling module 204 schedules an execution of a job for generation of the item of digital content. The execution of the job is performed at a content generation time that is prior to the optimal delivery time. The job scheduling module 204 may also identify the time segment between the content generation time and the optimal delivery time (e.g., how far prior to the optimal delivery time the content generation time should be) based on one or more factors (e.g., conditions, constraints, etc.) that are balanced for the purpose of timely delivery of digital content to the members.

The content generation module 206 executes the job at the content generation time. The executing of the job generates (e.g., results in the item of digital content.

The communication module 208 transmits one or more communications including the item of digital content to one or more devices associated with the one or more members. The one or more communications are transmitted at the optimal delivery time. In some example embodiments, the communication module 208 is further configured to transmit the one or more communications including the item of digital content to one or more devices associated with one or more connections of the one or more members. The one or more connections of a particular member of the SNS are other members of the SNS connected to the particular member via the social graph of the particular member. In certain example embodiments, the communication module 208 is further configured to transmit the one or more communications including the item of digital content to one or more devices associated with one or more subscribers to a group on the SNS.

The optimal time identifying module 210 determines the optimal delivery time for the one or more members. In some instances, the optimal delivery time is determined based on a high likelihood of the one or more members interacting with the item of content at the optimal delivery time. The optimal time identifying module 210 also associates one or more member identifiers (e.g., names, numbers, etc.) of the one or more members with the optimal delivery time.

In some example embodiments, the optimal time identifying module 210 computes the likelihood of the one or more members interacting with the item of content at the optimal delivery time based on past history and/or other factors (e.g., member activity and behavior data 132) associated with the one or more members and obtained during the operation of the social networking system 120 (or a component of the social networking system 120) using mathematical models. The optimal time identifying module 210 determines that the likelihood of the one or more members interacting with the item of content at the optimal delivery time is high based on the likelihood exceeding an interaction threshold value.

In certain example embodiments, the optimal time identifying module 210 associates the one or more members with the optimal delivery time based on a time zone associated with the one or more members.

The job tracking module 212 may determine that a previous job for generation of an item of content (e.g., the job prior to a current job) was completed. Based on the tracking module 212 determining that the previous job was completed, the content generation module 206 executes the current job (e.g., the job scheduled to be executed after the previous job) at the content generation time.

in some example embodiments, the job tracking module 212 determines that a previous job was not completed (e.g., the job failed or was not started due to problems with the underlying system). Based on the tracking module 212 determining that the previous job was not completed, the content generation module 206 executes the previous job at the content generation time as part of the current job (e.g., the job scheduled to execute at the content generation time). For example, the executing of the job that is subsequent to the previous job, at the content generation time, includes executing the previous job at the content generation time. As a result, at the content generation time, the content generation module 206 generates both a first item of digital content that should have been generated during the execution of the previous job and a second item of digital content that should be generated during the execution of the current job (e.g., the job subsequent to the previous job) scheduled to execute at the content generation time,

The timeliness evaluation module 214 selects the content generation time. The content generation time may be selected based on matching the content generation time and a time window during which the one or more members are likely to be interested in the item of digital content. The time window is determined (e.g., by the timeliness evaluation module 214 based on member activity and behavior data 132 that pertains to one or more members of the SNS.

The message generation module 216 groups one or more items of digital content, including the item of digital content, based on relevance to the one or more members. The message generation module 216 also generates one or more communications. The one or more communications comprise, the one or more items of digital content including the item of digital content. In some example embodiments, the grouping of the one or more items of digital content is based on relevance score values associated with the one or more items of digital content and a content selection rule. The content selection rule may specify, for example, that the one or more items of digital content that are associated with relevance score values that exceed a relevance threshold value should be included in a communication.

To perform one or more of its functionalities, the content generation system 200 may communicate with one or more other systems. An integration engine may integrate the content generation system 200 with one or more email server(s), web server(s), one or more databases, or other servers, systems, or repositories. A measurement and reporting engine may determine the performance of one or more modules of the content generation system 200. An optimization engine may optimize one or more of the models associated with one or more modules of the content generation system 200.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 218 (e.g., the database 128, 130, or 132).

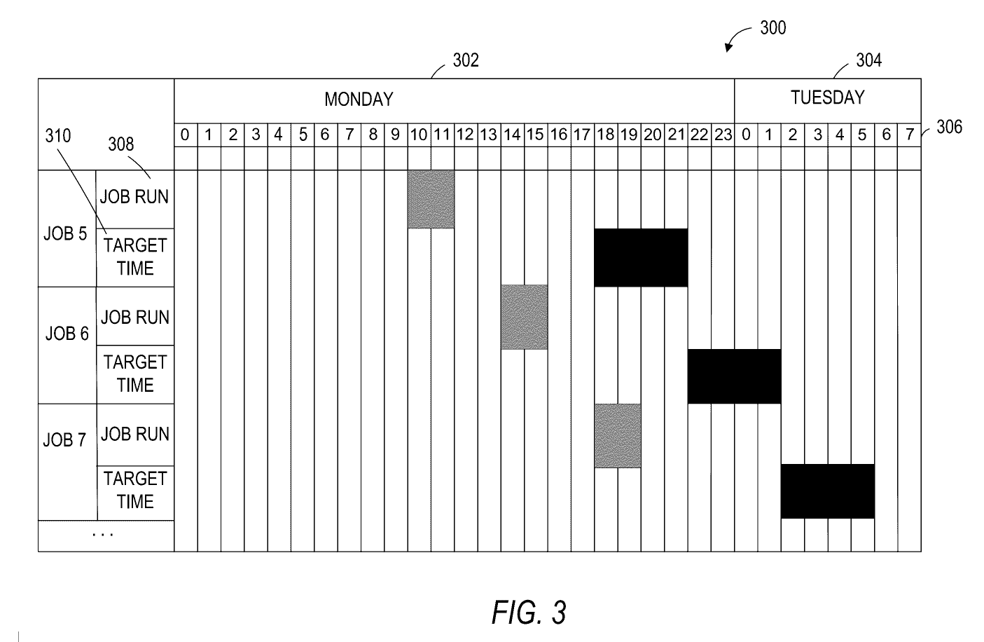

FIG. 3 is a diagram illustrating a representation of a schedule for content generation and content transmittal to members of a social networking service, according to some example embodiments. The content generation system 200 schedules the execution of content generation jobs associated with various groups of members and transmits the generated digital content to the members of the respective groups at the times optimal for the members of the respective groups.

The representation 300 illustrates an example schedule for content-related activities pertaining to various groups of members over two days (e.g., Monday 302 and Tuesday 304. Example of content-related activities are generating digital content and transmitting communications including the generated digital content to the members included in a group (e.g., a segment of the total membership of a social networking service). Each day (e.g., Monday 302 or Tuesday 304) is segmented into hourly slots 306, as illustrated in FIG. 3.

As shown in FIG. 3, three jobs, Job 5, Job 6, and Job 7, represent content generation and content transmittal events associated with three groups of members. Each of the Job 5, Job 6, and Job 7 is associated with a Job Run time 308 for executing the respective job (e.g., Job 5, Job 6, or Job 7) and a Target Time 310 (e.g., the optimal delivery time) for transmitting the item of digital content generated during the respective Job Run time 308 to the members of the group associated with the respective job (e.g., Job 5, Job 6, or Job 7).

As illustrated in FIG. 3, Job 5 is scheduled to execute during two hours between 10 a.m. and noon (e.g., hours 10 and 11) on Monday. The item of digital content generated as a result of running Job 5 is scheduled to be transmitted to the members of the group associated with Job 5 between 6 p.m. and 10 p.m. hours 18, 19, 20, and 21) on Monday. Similarly, Job 6 is scheduled to execute for two hours between 2 p.m. and 4 p.m. (e.g., hours 14 and 15) on Monday. The item of digital content generated as a result of running Job 6 is scheduled to be transmitted to the members of the group associated with Job 6 between 10 p.m. on Monday and 2 a.m. on Tuesday (e.g., hours 22 and 23 on Monday, and hours 0 and 1 on Tuesday). Similarly, Job 7 is scheduled to execute for two hours between 6 p.m. and 8 p.m. (e.g., hours 18 and 19) on Monday. The item of digital content generated as a result of running Job 7 is scheduled to be transmitted to the members of the group associated with Job 7 between 2 a.m. and 6 a.m. (e.g., hours 2, 3, 4, and 5) on Tuesday.

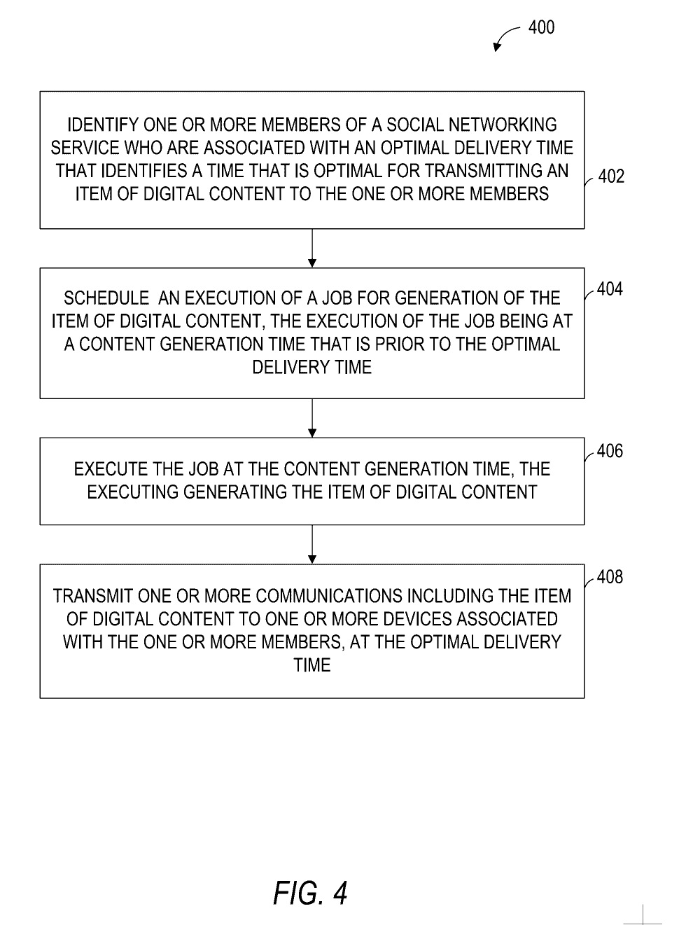

FIGS. 4-8 are flowcharts illustrating a method for scheduling content generation, according to some example embodiments. Operations in the method 400 illustrated in FIG. 4 may be performed using modules described above with respect to FIG. 2. As shown in FIG. 4, method 400 may include one or more of method operations 402, 404, 406, and 408, according to some example embodiments.

At method operation 402, the member grouping module 202 identifies one or more members of a social networking service who are associated with an optimal delivery time. The optimal delivery time identifies a time that is optimal for transmitting an item of digital content to the one or more members.

At method operation 404, the job scheduling module 204 schedules an execution of a job for generation of the item of digital content. The execution of the job is performed at a content generation time that is prior to the optimal delivery time.

At method operation 406, the content generation module 206 executes the job at the content generation time. The executing of the job generates (e.g., results in) the item of digital content.

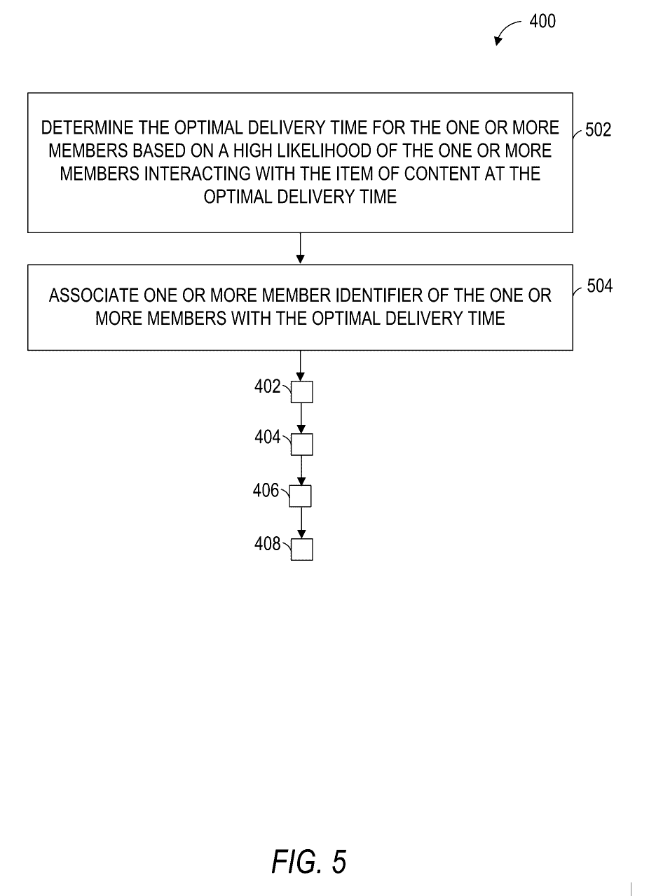

At method operation 408, the communication module 208 transmits one or more communications including the item of digital content to one or more devices associated with the one or more members. The one or more communications are transmitted at the optimal delivery time. In some example embodiments, the communication module 208 is further configured to transmit the one or more communications including the item of digital content to one or more devices associated with one or more connections of the one or more members. In certain example embodiments, the communication module 208 is further configured to transmit the one or more communications including the item of digital content to one or more devices associated with one or more subscribers of a social networking service group. Further details with respect to the method operations of the method 400 are described below with respect to FIGS. 5-8.

As shown in FIG. 5, the method 400 may include method operations 502 and 504, according to some example embodiments. Method operation 502 may be performed before method operation 402, in which the member grouping module 202 identifies one or more members of a social networking service who are associated with an optimal delivery time.

At method operation 502, the optimal time identifying module 210 determines the optimal delivery time for the one or more members. The determining of the optimal delivery time may be based on a high likelihood of the one or more members interacting with the item of content at the optimal delivery time. In some example embodiments, the optimal time identifying module 210 computes the likelihood of the one or more members interacting with the item of content at the optimal delivery time, and determines that the likelihood of the one or more members interacting with the item of content at the optimal delivery time is high based on the likelihood exceeding an interaction threshold value.

At method operation 504, the optimal time identifying module 210 associates one or more member identifiers (e.g., names, numbers, etc.) of the one or more members with the optimal delivery time.

In some example embodiments, the optimal time identifying module 210 associates the one or more members with the optimal delivery time based on a time zone associated with the one or more members.

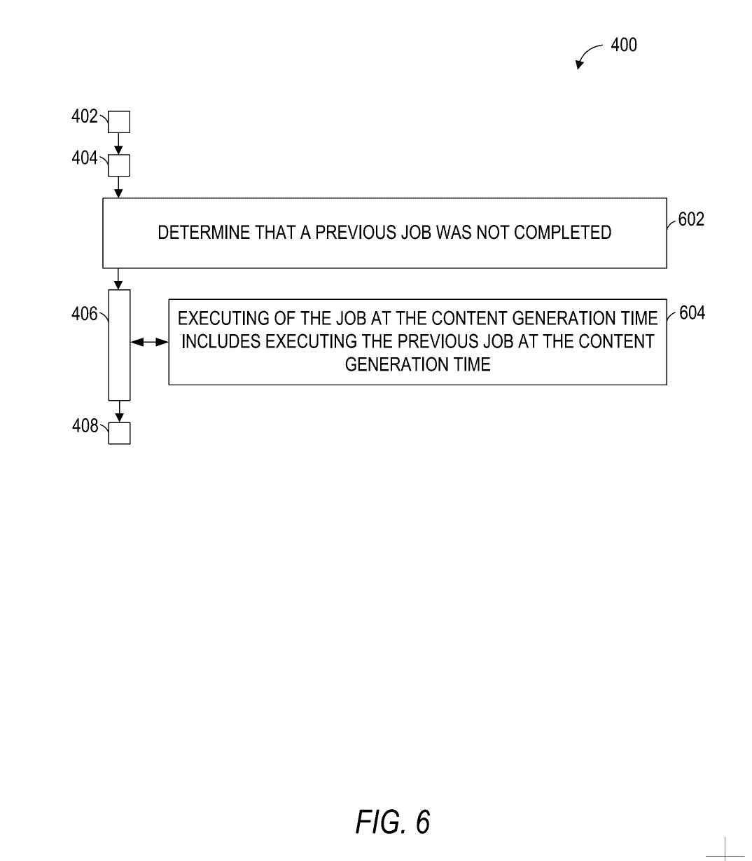

As shown in FIG. 6, the method 400 may include one or more of operations 602 and 604, according to some example embodiments. Method operation 602 may be performed after method operation 404, in which the job scheduling module 204 schedules an execution of a job for generation of the item of digital content. At method operation 602, the job tracking module 212 determines that a previous job was not completed.

Method operation 604 is performed as part (e.g., a precursor task, a subroutine, or a portion) of method operation 406, in which the content generation module 206 executes the job at the content generation time. At method operation 604, the content generation module 206 executes the previous job at the content generation time. In some example embodiments, the execution of the previous job is performed at the content generation time associated with the current job before the execution of the current job at the content generation time associated with the current job.

In some example embodiments, the job tracking module 212 determines that a previous job was completed. The executing of the job (e.g., the current job) at the content generation time is performed based on determining that the previous job was completed.

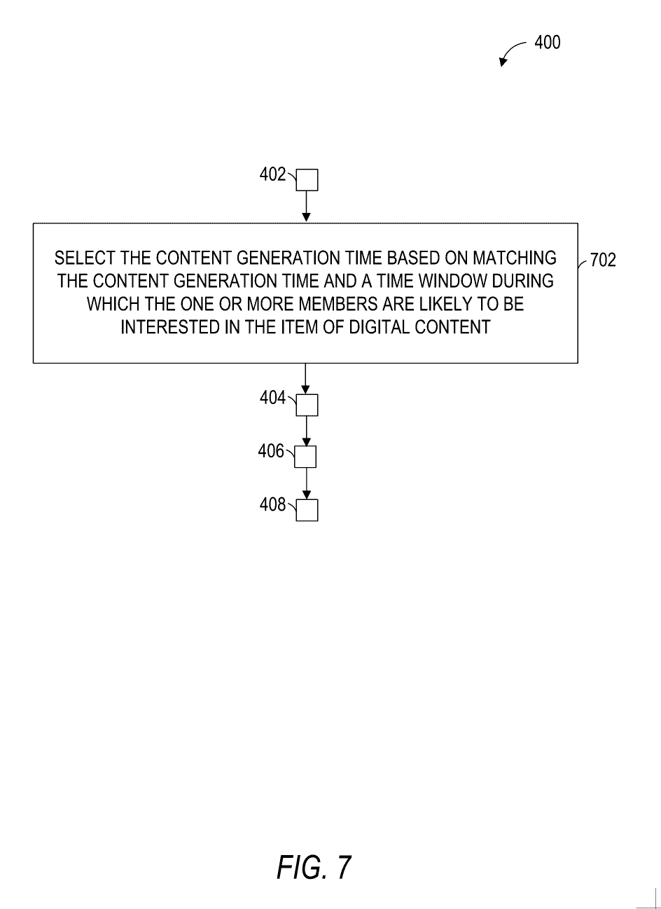

As shown in FIG. 7, the method 400 may include method operation 702, according to some example embodiments. Method operation 702 may be performed after method operation 402, in which the member grouping module 202 identifies one or more members of the SNS who are associated with an optimal delivery time. The time window may be determined (e.g., by the timeliness evaluation module 214) based on member activity and behavior data 132 that pertains to one or more members of the SNS.

At method operation 702, the timeliness evaluation module 214 selects the content generation time. The selecting of the content generation time may be based on matching the content generation time and a time window during which the one or more members are likely to be interested in the item of digital content.

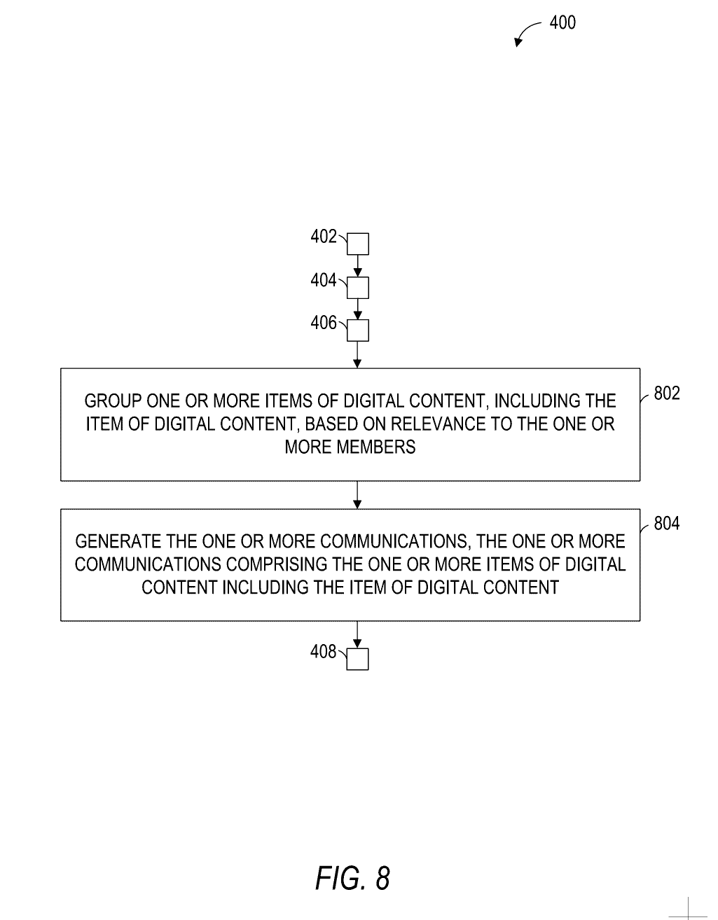

As shown in FIG. 8, the method 400 may include method operations 802 and 804, according to some example embodiments. Method operation 802 may be performed after method operation 406, in which the content generation module 206 executes the job at the content generation time.

At method operation 802, the message generation module 216 groups one or more items of digital content including the item of digital content. The one or more items of digital content may be grouped based on relevance to the one or more members. In some example embodiments, the grouping of the one or more items of digital content is based on relevance score values associated with the one or more items of digital content and a content selection rule. For example, content item 1 is associated with a relevance score value of 0.5 for engineers, content item 2 is associated with a relevance score value of 0.2 for engineers, and content item 3 is associated with a relevance score value of 0.7 for engineers. A content selection rule may specify that “If the member is an engineer, then select a content item that has a relevance score value that is equal to or exceeds 0.5.” The message generation module 216 may apply this content selection rule to content items 1 through 3, and group content items 1 and 3 based on each of the respective relevance score value associated with content items 1 and 3 exceeding the specified threshold value of 0.5.

At method operation 804, the message generation module 216 generates the one or more communications. The one or more communications comprise the one or more items of digital content including the item of digital content. Based on the example above, one or more communications comprise content items 1 and 3.

### Example Mobile Device

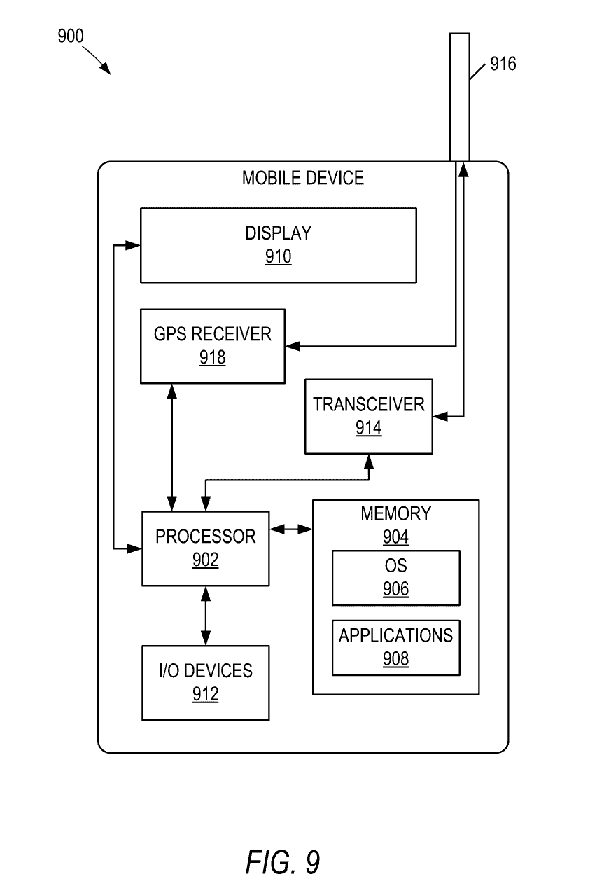

FIG. 9 is a block diagram illustrating a mobile device 900, according to an example embodiment. The mobile device 900 may include a processor 902. The processor 902 may be any of a variety of different types of commercially available processors 902 suitable for mobile devices 900 (for example, an XScale architecture microprocessor, a microprocessor without interlocked pipeline stages (MIPS) architecture processor, or another type of processor 902). A memory 904, such as a random access memory (RAM), a flash memory, or other type of memory, is typically accessible to the processor 902. The memory 904 may be adapted to store an operating system (OS) 906, as well as application programs 908, such as a mobile location enabled application that may provide LBSs to a user. The processor 902 may be coupled, either directly or via appropriate intermediary hardware, to a display 910 and to one or more input/output (I/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive UPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may he driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and; or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a. programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

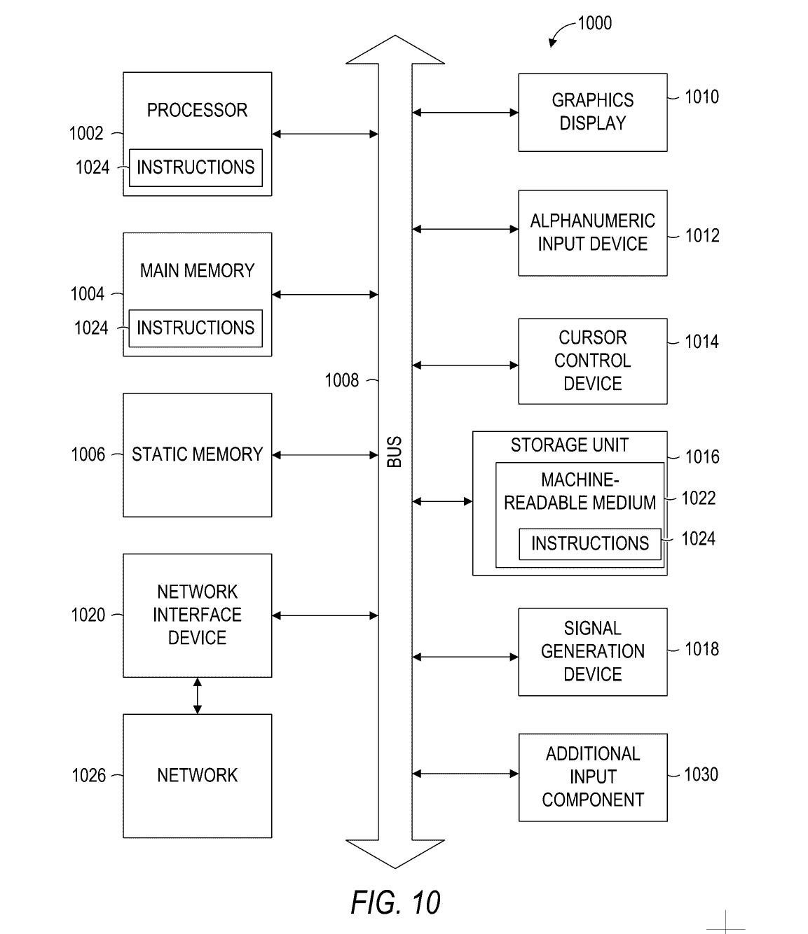

FIG. 10 is a block diagram illustrating components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFC), or any suitable combination thereof), a main memory 1004, and a static memory 1006, which are configured to communicate with each other via a bus 1008. The processor 1002 may contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 1026 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software,) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
identifying one or more members of a social networking service (SNS) who are associated with an optimal delivery time that identifies a time that is optimal for transmitting an item of digital content to the one or more members;
scheduling, using one or more hardware processors, an execution of a job for generation of the item of digital content, the execution of the job being performed at a content generation time that is prior to the optimal delivery time;
executing the job at the content generation time, the executing generating the item of digital content; and
transmitting one or more communications including the item of digital content to one or more devices associated with the one or more members, at the optimal delivery time.

2. The method of claim 1, further comprising:
determining the optimal delivery time for the one or more members based on a high likelihood of the one or more members interacting with the item of content at the optimal delivery time; and
associating one or more member identifiers of the one or more members with the optimal delivery time.

3. The method of claim 1, further comprising:
computing a likelihood of the one or more members interacting with the item of content at the optimal delivery time; and
determining that the likelihood of the one or more members interacting with the item of content at the optimal delivery time is high based on the likelihood exceeding an interaction threshold value.

4. The method of claim 1, further comprising:
associating the one or more members with the optimal delivery time based on a time zone associated with the one or more members.

5. The method of claim 1, further comprising:
determining that a previous job was completed,
wherein the executing of the job at the content generation time is performed based on determining that the previous job was completed.

6. The method of claim 1, further comprising:
determining that a previous job was not completed,
wherein the executing of the job at the content generation time includes executing the previous job at the content generation time.

7. The method of claim 1, further comprising:
selecting the content generation time based on matching the content generation time and a time window during which the one or more members are likely to be interested in the item of digital content.

8. The method of claim 1, further comprising:
grouping one or more items of digital content, including the item of digital content, based on relevance to the one or more members; and
generating the one or more communications, the one or more communications comprising the one or more items of digital content including the item of digital content.

9. The method of claim 8, wherein the grouping of the one or more items of digital content is based on relevance score values associated with the one or more items of digital content and a content selection rule.

10. The method of claim 1, further comprising:
transmitting the one or more communications including the item of digital content to one or more devices associated with one or more connections of the one or more members.

11. The method of claim 1, further comprising:
transmitting the one or more communications including the item of digital content to one or more devices associated with one or more subscribers of an SNS group.

12. A system comprising:
a machine-readable medium for storing instructions that, when executed by one or more hardware processors, cause the system to perform operations comprising:
identifying one or more members of a social networking service (SNS) who are associated with an optimal delivery time that identifies a time that is optimal for transmitting an item of digital content to the one or more members;
scheduling an execution of a job for generation of the item of digital content, the execution of the job being performed at a content generation time that is prior to the optimal delivery time;
executing the job at the content generation time, the executing generating the item of digital content; and
transmitting one or more communications including the item of digital content to one or more devices associated with the one or more members, at the optimal delivery time.

13. The system of claim 12, wherein the operations further comprise:
determining the optimal delivery time for the one or more members based on a high likelihood of the one or more members interacting with the item of content at the optimal delivery time; and
associating one or more member identifiers of the one or more members with the optimal delivery time.

14. The system of claim 12, wherein the operations further comprise:
associating the one or more members with the optimal delivery time based on a time zone associated with the one or more members.

15. The system of claim 12, wherein the operations further comprise:
determining that a previous job was completed,
wherein the executing of the job at the content generation time is performed based on determining that the previous job was completed.

16. The system of claim 12, wherein the operations further comprise:
determining that a previous job was not completed,
wherein the executing of the job at the content generation time includes executing the previous job at the content generation time.

17. The system of claim 12, wherein the operations further comprise:
selecting the content generation time based on matching the content generation time and a time window during which the one or more members are likely to be interested in the item of digital content.

18. The system of claim 12, wherein the operations further comprise:
grouping one or more items of digital content, including the item of digital content, based on relevance to the one or more members; and
generating the one or more communications, the one or more communications comprising the one or more items of digital content including the item of digital content.

19. The system of claim 12, wherein the operations further comprise:
transmitting the one or more communications including the item of digital content to one or more devices associated with one or more connections of the one or more members.

20. A non-transitory machine-readable storage medium comprising instructions that, when executed by one or more hardware processors of a machine, cause the machine to perform operations comprising:
identifying one or more members of a social networking service who are associated with an optimal delivery time that identifies a time that is optimal for transmitting an item of digital content to the one or more members;
scheduling an execution of a job for generation of the item of digital content, the execution of the job being performed at a content generation time that is prior to the optimal delivery time;
executing the job at the content generation time, the executing generating the item of digital content; and
transmitting one or more communications including the item of digital content to one or more devices associated with the one or more members, at the optimal delivery time.
